(19) United States
(12) Patent Application Publication
(10) Pub. No.: US 2019/0030962 A1
(43) Pub. Date: Jan. 31, 2019

(54) Pneumatic Tire

(71) Applicant: The Yokohama Rubber Co., LTD., Minato-ku, Tokyo (JP)

(72) Inventor: Tatsuro Shinzawa, Hiratsuka-shi, Kanagawa (JP)

(21) Appl. No.: 16/071,463

(22) PCT Filed: Dec. 20, 2016
(86) PCT No.: PCT/JP2016/087951

§ 371 Date: Jul. 19, 2018

(30) Foreign Application Priority Data
Jan. 19, 2016 (JP) 2016-008126

(51) Int. Cl. B60C 19/00; C08L 21/00; C08L 81/04; C08K 5/45; B60C 1/00

(52) U.S. Cl. CPC B60C 19/002; C08L 21/00; B60C 1/0016; C08K 5/45; C08L 81/04

(57) ABSTRACT

In a pneumatic tire provided with a band-like sound absorbing member adhered on a tire inner surface of a tread portion in a tire circumferential direction, a rubber composition constituting the tread portion contains a particular cyclic polysulfide, a compounded amount thereof is in a particular range specified by an average thickness of the sound absorbing member in the tire circumferential direction or by a ratio of an average width of the sound absorbing member in the tire circumferential direction to a width of a belt layer.

### TECHNICAL FIELD

The present technology relates to a pneumatic tire provided with a tire noise reduction device and particularly relates to a pneumatic tire that can prevent reduction in tire performance due to accumulation of heat in a band-like sound absorbing member during high-speed traveling while sufficient quietness is achieved by the band-like sound absorbing member mounted on a tire inner surface.

### BACKGROUND ART

One of the factors that generate tire noise is cavernous resonance caused by the vibration of the air filled in a cavity portion (tire cavity) formed in a tire when the tire is mounted on a rim. This cavernous resonance occurs when a tread portion of a tire that contacts a road surface vibrating due to unevenness or the like of the road surface when a vehicle is driven, and this vibration vibrates the air in the tire cavity. Because, among the cavernous resonance, sound in a particular frequency band is perceived as noise, it is important to reduce the level of sound pressure in the frequency band (level of noise) from the perspective of reducing the tire noise.

As a method of reducing such noise, it has been proposed to introduce a sound absorbing member formed from a porous material, such as a sponge, in the tire cavity. For example, in a pneumatic tire described in Japanese Patent Publication No. 4281874, such a sound absorbing member is mounted on an inner circumferential surface of a tread portion by using an elastic band. However, in this case, the elastic band may be deformed during high-speed traveling, and this may cause a problem that the sound absorbing member cannot be appropriately mounted.

Japanese Patent Publication No. 5267288 proposes directly adhering a sound absorbing member on an inner circumferential surface of a tread portion by using an adhesive or the like without the use of the elastic band described above. However, in this case, because the sound absorbing member is directly adhered on the tire inner surface, heat is easily accumulated in the tread portion during high-speed traveling. This causes a problem of deterioration of the tire performance due to the accumulated heat (loss of grip caused by heat).

### SUMMARY

The present technology provides a pneumatic tire that is provided with a tire noise reduction device and that can prevent reduction in tire performance due to accumulation of heat in a band-like sound absorbing member during high-speed traveling while sufficient quietness is achieved by the band-like sound absorbing member mounted on a tire inner surface.

A pneumatic tire of a first embodiment of the present technology includes: a tread portion having an annular shape and extending in a tire circumferential direction; a pair of sidewall portions disposed on both sides of the tread portion; a pair of bead portions disposed on an inner side of the sidewall portions in a tire radial direction; and a band-like sound absorbing member adhered on a tire inner surface of the tread portion in the tire circumferential direction; a rubber composition constituting the tread portion containing a cyclic polysulfide represented by Formula (1); and when a compounded amount of the cyclic polysulfide per 100 parts by mass of a sulfur vulcanizable rubber in the rubber composition constituting the tread portion is C and an average thickness of the sound absorbing member in the tire circumferential direction is D, the compounded amount C satisfying Expression (2).

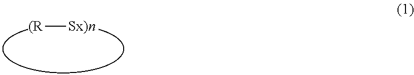

where, R is a substituted or unsubstituted alkylene group having from 2 to 20 carbons, a substituted or unsubstituted oxyalkylene group having from 2 to 20 carbons, or an alkylene group having an aromatic ring; n is an integer of 1 to 20; and xis a number, on average, of 2 to 6.

(D−10)×0.015+0.2<C<(D−10)×0.015+6 (2)

In the expression, D is 10 mm or greater.

To achieve the objects described above, a pneumatic tire of a second embodiment of the present technology includes: a tread portion having an annular shape and extending in a tire circumferential direction; a pair of sidewall portions disposed on both sides of the tread portion; a pair of bead portions disposed on an inner side of the sidewall portions in a tire radial direction; a carcass layer mounted between the pair of bead portions; a belt layer disposed on an outer circumferential side of the carcass layer in the tread portion; and a band-like sound absorbing member adhered on a tire inner surface of the tread portion in the tire circumferential direction; a rubber composition constituting the tread portion containing a cyclic polysulfide represented by Formula (1); and when a compounded amount of the cyclic polysulfide per 100 parts by mass of a sulfur vulcanizable rubber in the rubber composition constituting the tread portion is C, an average width of the sound absorbing member in the tire circumferential direction is W, and a width of the belt layer is B, the compounded amount C satisfying Expression (3).

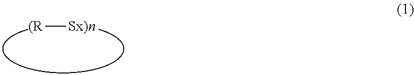

where, R is a substituted or unsubstituted alkylene group having from 2 to 20 carbons, a substituted or unsubstituted oxyalkylene group having from 2 to 20 carbons, or an alkylene group having an aromatic ring; n is an integer of 1 to 20; and xis a number, on average, of 2 to 6.

(W/B)×0.6+0.1<C<(W/B)×0.6+6 (3)

In the expression, W is 50 mm or greater.

To achieve the objects described above, a pneumatic tire of a third embodiment of the present technology includes: a tread portion having an annular shape and extending in a tire circumferential direction; a pair of sidewall portions disposed on both sides of the tread portion; a pair of bead portions disposed on an inner side of the sidewall portions in a tire radial direction; a carcass layer mounted between the pair of bead portions; a belt layer disposed on an outer circumferential side of the carcass layer in the tread portion; and a band-like sound absorbing member adhered on a tire inner surface of the tread portion in the tire circumferential direction; a rubber composition constituting the tread portion containing a cyclic polysulfide represented by Formula (1); and when a compounded amount of the cyclic polysulfide per 100 parts by mass of a sulfur vulcanizable rubber in the rubber composition constituting the tread portion is C, an average thickness of the sound absorbing member in the tire circumferential direction is D, an average width of the sound absorbing member in the tire circumferential direction is W, and a width of the belt layer is B, in the case where a ratio W/B of the average width W to the width B is less than 0.5, the compounded amount C satisfying Expression (2) and, in the case where the ratio W/B of the average width W to the width B is 0.5 or greater, the compounded amount C satisfying Expression (3).

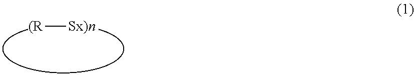

where, R is a substituted or unsubstituted alkylene group having from 2 to 20 carbons, a substituted or unsubstituted oxyalkylene group having from 2 to 20 carbons, or an alkylene group having an aromatic ring; n is an integer of 1 to 20; and x is a number, on average, of 2 to 6.

(D−10)×0.015+0.2<C<(D−10)×0.015+6 (2)

In the expression, D is 10 mm or greater.

(W/B)×0.6+0.1<C<(W/B)×0.6+6 (3)

In the expression, W is 50 mm or greater.

In any case of the pneumatic tires of the first to the third embodiments of the present technology, the rubber composition constituting the tread portion contains a particular cyclic polysulfide as described above. Such rubber composition containing the cyclic polysulfide has excellent bending fatigue resistance, wear resistance, and heat aging resistance. These characteristics prevent reduction in tire performance due to accumulation of heat (loss of grip caused by heat) even when a sound absorbing member is directly adhered, thereby easily causing the accumulation of heat. Because the compounded amount C of the cyclic polysulfide is set to an appropriate range at this time depending on an average thickness D of the band-like sound absorbing member in the pneumatic tire of the first embodiment, an average width W of the band-like sound absorbing member (strictly, a ratio W/B of the average width W to a belt width B) in the pneumatic tire of the second embodiment, and the average thickness D or the average width W (the ratio W/B) in the pneumatic tire of the third embodiment, loss of grip caused by heat can be effectively prevented without impairing quietness of the tire.

In an embodiment of the present technology, the volume of the band-like sound absorbing member is preferably from 10% to 30% of the cavity volume of the tire. Sound absorbing effect can be effectively obtained by setting the size of the band-like sound absorbing member to an appropriate size relative to the tire cavity as described above.

In an embodiment of the present technology, the band-like sound absorbing member preferably has a missing portion at at least one position in the tire circumferential direction. By this, it becomes possible to tolerate deformation of a tire during inflation (expansion of the tire) and/or shearing strain at the contact surface due to rolling on ground for a long period of time.

In an embodiment of the present technology, a substance in which the R moiety in Formula (1) above is —CH₂—CH₂—O—CH₂—O—CH₂—CH₂— can be suitably used.

Note that, in an embodiment of the present technology, dimensions and cavity volume of the tire are measured with the tire mounted on a regular rim and inflated to the regular internal pressure. In particular, “cavity volume of tire” is a volume of the cavity portion formed in between the tire and the rim in this condition. Furthermore, “ground contact width” described below is a length between the ground contact edges on both edge portions in the tire axial direction when the tire in this condition is placed vertically on a flat surface and 60% of regular load is applied thereto. “Regular rim” is a rim defined by a standard for each tire according to a system of standards that includes standards on which tires are based, and refers to a “standard rim” in the case of JATMA, refers to a “design rim” in the case of TRA, and refers to a “measuring rim” in the case of ETRTO. “Regular internal pressure” is air pressure defined by standards for each tire according to a system of standards that includes standards on which tires are based, and refers to a “maximum air pressure” in the case of JATMA, refers to the maximum value in the table of “TIRE ROAD LIMITS AT VARIOUS COLD INFLATION PRESSURES” in the case of TRA, and refers to the “INFLATION PRESSURE” in the case of ETRTO. However, the air pressure which is displayed on the vehicle is used in a case where the tire is an original equipment tire. “Regular load” is a load defined by a standard for each tire according to a system of standards that includes standards on which tires are based, and refers to a “maximum load capacity” in the case of JATMA, refers to the maximum value in the table of “TIRE ROAD LIMITS AT VARIOUS COLD INFLATION PRESSURES” in the case of TRA, and refers to “LOAD CAPACITY” in the case of ETRTO.

### BRIEF DESCRIPTION OF DRAWINGS

FIG. 1 is a perspective cross-sectional view of a pneumatic tire according to an embodiment of the present technology.

FIG. 2 is a cross-sectional view taken along the equator line of the pneumatic tire according to the embodiment of the present technology.

### DETAILED DESCRIPTION

The configuration of the present technology is described in detail below with reference to the accompanying drawings.

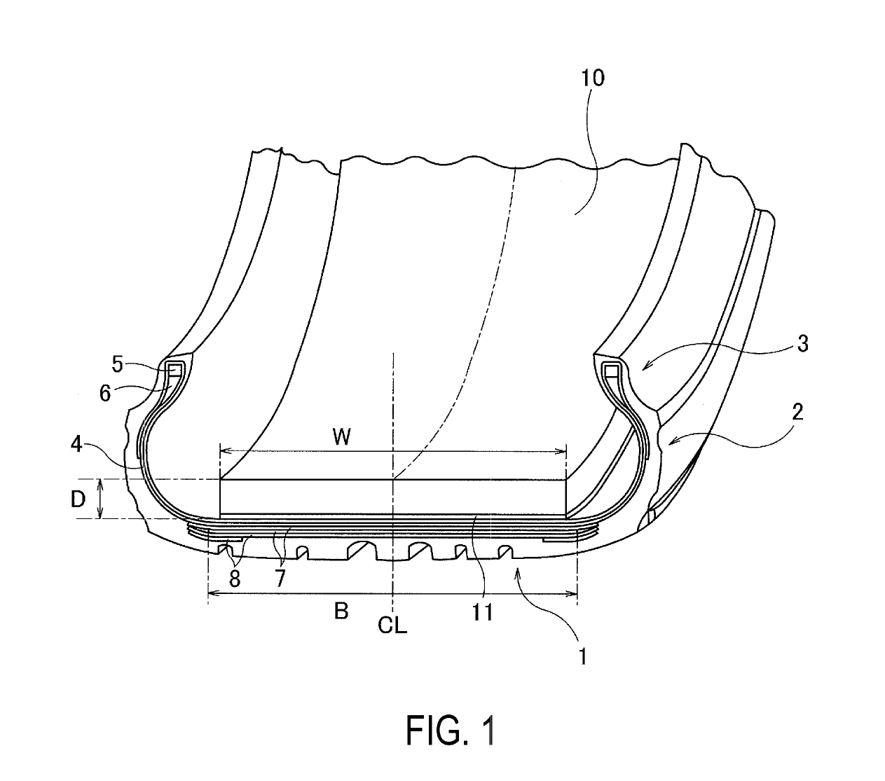

Reference sign CL in FIG. 1 denotes the tire equator. The pneumatic tire according to an embodiment of the present technology is formed from a tread portion 1 having an annular shape and extending in the tire circumferential direction, a pair of sidewall portions 2 disposed on both sides of the tread portion 1, and a pair of bead portions 3 disposed inward of the sidewall portions 2 in the tire radial direction.

A carcass layer 4 is mounted between the left-right pair of bead portions 3. The carcass layer 4 includes a plurality of reinforcing cords extending in the tire radial direction, and is folded back around a bead core 5 disposed in each of the bead portions 3 from a vehicle inner side to a vehicle outer side. Additionally, bead fillers 6 are disposed on the periphery of the bead cores 5, and each bead filler 6 is enveloped by a main body portion and a folded back portion of the carcass layer 4. On the other hand, a plurality (in the example of the figure, two layers) of belt layers 7 are embedded on an outer circumferential side of the carcass layer 4 in the tread portion 1. The belt layers 7 each include a plurality of reinforcing cords that are inclined with respect to the tire circumferential direction, the direction of the reinforcing cords of the different layers intersect each other. In these belt layers 7, the inclination angle of the reinforcing cords with respect to the tire circumferential direction is set in the range, for example, of 10° to 40°. In addition, a belt reinforcing layer 8 is provided on the outer circumferential side of the belt layers 7. In particular, in the example illustrated in the figure, two layers of the belt reinforcing layers 8, which are a layer covering the entire width of the belt layer 7 and a layer only covering the edges in the width direction of the belt layer 7, are provided. The belt reinforcing layer 8 includes organic fiber cords oriented in the tire circumferential direction. In the belt reinforcing layer 8, the angle of the organic fiber cords with respect to the tire circumferential direction is set, for example, to from 0° to 5°.

In an embodiment of the present technology, the band-like sound absorbing member 10 is mounted as described below on such a typical pneumatic tire, and the cross sectional structure of the pneumatic tire on which the band-like sound absorbing member 10 is mounted is not limited to the basic structure described above.

The band-like sound absorbing member 10 is formed from a porous material with open cells, and has predetermined sound absorbing properties based on the porous structure. For example, polyurethane foam can be used as the porous material constituting the band-like sound absorbing member 10.

This band-like sound absorbing member 10 is adhered via, for example, an adhesive layer 11 in the region on the tire inner surface corresponding to the tread portion 1. For example, a double-sided tape is preferably used as the adhesive layer 11.

The dimension of the band-like sound absorbing member 10 may be appropriately set depending on the size of the pneumatic tire on which the band-like sound absorbing member 10 is mounted and/or the desired sound absorbing performance and is not limited. For example, the volume of the band-like sound absorbing member 10 is preferably set to 10% to 30% of the cavity volume of the tire. Furthermore, the average width W of the band-like sound absorbing member 10 is preferably set to, for example, 30% to 90% relative to the ground contact width of the tire. When the band-like sound absorbing member 10 having such a dimension is used, the sound absorbing effect due to the band-like sound absorbing member 10 can be effectively achieved. At this time, when the volume of the band-like sound absorbing member 10 is less than 10% of the cavity volume of the tire, it becomes difficult to achieve the sound absorbing effect sufficiently. On the other hand, even when the volume of the band-like sound absorbing member 10 is greater than 30% of the cavity volume of the tire, effect of reducing the cavernous resonance is fixed, and thus further noise reduction effect cannot be expected.

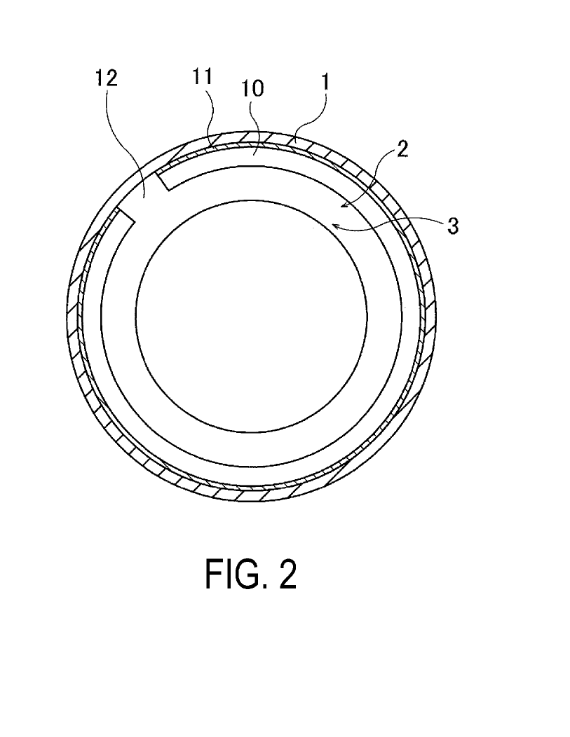

As the band-like sound absorbing member 10, use of a band-like sound absorbing member having a missing portion 12, at which the band-like sound absorbing member 10 is not present, at at least one position in the tire circumferential direction as illustrated in FIG. 2 is preferable. Expansion of the tire during inflation and/or shearing strain due to rolling on ground can be tolerated for a long period of time by providing the missing portion 12 as described above. The missing portion 12 is preferably provided at 1 position or 3 to 5 positions on the tire circumference. That is, when the missing portions 12 are provided at 2 positions on the tire circumference, tire uniformity due to mass unbalance significantly deteriorates, and when the missing positions 12 are provided at 6 or more positions on the circumference, production cost significantly increases.

In any case, because the sound absorbing member 10 is present in the tire cavity in an embodiment of the present technology, cavernous resonance can be reduced by the sound absorbing characteristics, and quietness can be enhanced. However, because the band-like sound absorbing member 10 is directly adhered to the inner surface of the tread portion 1 as described above, accumulation of heat easily occurs in the tread portion 1 (adhered position of the sound absorbing member 10) during high-speed traveling. Therefore, in an embodiment of the present technology, a rubber composition containing a cyclic polysulfide represented by Formula (1) below is employed as the rubber composition constituting the tread portion 1.

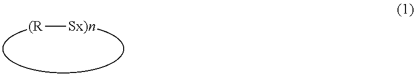

In the formula, R is a substituted or unsubstituted alkylene group having from 2 to 20 carbons, a substituted or unsubstituted oxyalkylene group having from 2 to 20 carbons, or an alkylene group having an aromatic ring; n is an integer of 1 to 20; and xis a number, on average, of 2 to 6.

Because the rubber composition containing the cyclic polysulfide has excellent characteristics of bending fatigue resistance, wear resistance, and heat aging resistance, deterioration of tire performance due to the heat accumulation (loss of grip caused by heat) can be prevented by enhancing the heat aging resistance and the like of this portion by using the rubber composition in the tread portion 1 (adhered position of the band-like sound absorbing member 10) for which heat accumulation is concerned as described above.

Although specific type of the cyclic polysulfide represented by Formula (1) above is not limited, a cyclic polysulfide in which the R moiety is —CH₂—CH₂—O—CH₂—O—CH₂—CH₂— can be suitably used, for example.

In an embodiment of the present technology, the compounded amount C of the cyclic polysulfide to a particular range depending on the dimension of the band-like sound absorbing member 10 adhered onto the tire inner side when the cyclic polysulfide is blended as described above. As a result, good maintenance of quietness and prevention of loss of grip caused by heat are provided in a compatible balance, and excellent effect due to blending of the cyclic polysulfide is achieved without deteriorating quietness by the band-like sound absorbing member 10. That is, the compounded amount C (part by mass) of the cyclic polysulfide per 100 parts by mass of the sulfur vulcanizable rubber in the rubber composition constituting the tread portion 1 relative to the average thickness D (mm) of the band-like sound absorbing member 1 in the tire circumferential direction is set to satisfy the Expression (2) below.

(D−10)×0.015+0.2<C<(D−10)×0.015+6 (2)

In the expression, D is 10 mm or greater.

Alternatively, the compounded amount C (part by mass) of the cyclic polysulfide per 100 parts by mass of the sulfur vulcanizable rubber in the rubber composition constituting the tread portion 1 relative to the average width W (mm) of the band-like sound absorbing member 10 in the tire circumferential direction and the width B (mm) of the belt layer 7 is set to satisfy the Expression (3) below. Note that, when a plurality of belt layers 7 are provided as illustrated in the example of FIG. 1, the width of the second belt layer 7, counted from the side of the carcass layer 4 in the tread portion 1, is used as the width B.

(W/B)×0.6+0.1<C<(W/B)×0.6+6 (3)

In the expression, W is 50 mm or greater.

As described above, the compounded amount C of the cyclic polysulfide is set to an appropriate range depending on the dimension of the band-like sound absorbing member (the average thickness D, the average width W, strictly, the ratio W/B of the average width W to the belt width B). This effectively prevents loss of grip caused by heat without impairing quietness of the tire. In any case, when an excessive amount, compared to the range of the compounded amount C defined in Expression (2) or (3) above, of the cyclic polysulfide is blended, hardness of the tread portion 1 increases and modulus of the tread portion 1 increases, and thus quietness and steering stability of the tire are deteriorated. On the other hand, when the compounded amount C of the cyclic polysulfide is less than the range defined in Expression (2) or (3) above, the cyclic polysulfide is not sufficiently blended. As a result, the effect obtained by blending the cyclic polysulfide (prevention of loss of grip due to excellent heat aging resistance) is not achieved.

Any range of the compounded amount C set by Expression (2) and (3) described above can be set for a discretionary band-like sound absorbing member. The range of the compounded amount C is preferably applied, on a case-by-case basis, depending on the ratio W/B of the width W of the band-like sound absorbing member 10 to the width B of the belt layer 7. That is, when the ratio W/B is small, the width W of the band-like sound absorbing member relative to the belt width B is small, and the covered proportion of the band-like sound absorbing member 10 relative to the inner surface of the tread portion 1 is small, the contact area of the band-like sound absorbing member 10 relative to the inner surface of the tread portion 1 becomes small while the band-like sound absorbing member 10 has a thickness, the portion that accumulates heat is limited, and heat dissipation from the inner surface of the tread portion 1 that is not covered with the band-like sound absorbing member 10 is also expected. Therefore, because the effect of the average thickness D of the band-like sound absorbing member 10 decreases and the effect of the average width W of the band-like sound absorbing member 10 increases, Expression (3) above including the average width W is preferably employed. On the other hand, when the ratio W/B is large, the width W of the band-like sound absorbing member 10 relative to the belt width B is large, and the covered proportion of the band-like sound absorbing member 10 relative to the inner surface of the tread portion 1 is large, it is premised that the heat accumulation occurs in a wide region of the inner surface of the tread portion 1. Such heat accumulation significantly affects the average thickness D of the band-like sound absorbing member 10 (that is, bulkiness of the sound absorbing member 10). Thus, Expression (2) above including the average thickness D is preferably employed.

Note that, depending on the dimension (the average thickness D, the average width W) of the band-like sound absorbing member 10, either one of the ranges defined by Expression (2) and Expression (3) is included in the other range. In such a case, the compounded amount C of the cyclic polysulfide may simultaneously satisfy both the ranges defined by Expression (2) and (3).

### EXAMPLES

Twelve types of pneumatic tires of Conventional Example 1, Comparative Examples 1 to 6, and Examples 1 to 5, which had a tire size of 275/35ZR20 V105D, had a basic structure illustrated in FIG. 1, and had the compounded amount C of the cyclic polysulfide in the rubber composition constituting the tread portion, the average thickness D of the band-like sound absorbing member, the width B of the belt layer, and the average width W of the band-like sound absorbing member each set as shown in Table 1, were produced.

Note that, Table 1 also shows the left side and the right side of Expression (2), whether the range defined by Expression (2) was satisfied, the ratio W/B of each example, the left side and the right side of Expression (3), and whether the range defined by Expression (3) was satisfied. The rows of “range of Expression (2)” and “range of Expression (3)” in Table 1 indicate whether the range defined by each expression was satisfied. The case where the range defined by each expression was satisfied was indicated by “satisfied”, and the case where it was not satisfied was indicated by “not satisfied”.

These 12 types of pneumatic tires were evaluated for resistance to the loss of grip caused by heat and quietness by the evaluation methods described below. The results are also shown in Table 1.

### Resistance to Loss of Grip Caused by Heat

Each of the test tires was mounted on a wheel having a rim size of 20×9.5J, inflated to the air pressure of 230 kPa, and mounted on a test vehicle with engine displacement of 3000 cc. Traveling test, in which a test driver drives a 5 km circuit course for five times, was performed, and the loss of grip caused by heat was evaluated by a sensory evaluation. The evaluation result was indicated on a scale of one to five with the result of Conventional Example 1 expressed as 3. A larger grade indicates less loss of grip caused by heat and superior resistance to loss of grip caused by heat.

### Quietness

Each of the test tires was mounted on a wheel having a rim size of 20×9.5J, inflated to the air pressure of 230 kPa, and mounted on a test vehicle with engine displacement of 3000 cc. The test vehicle was driven on a test course formed from an asphalt road surface at an average speed of 50 km/h. The level of sound pressure of the noise collected by a microphone attached at a window position of driver's seat was measured. As the evaluation result, the reciprocal of the measured value was indicated on a scale of one to five with the reciprocal of the result of Conventional Example 1 expressed as 3. A larger grade indicates superior quietness.

TABLE 1

| | | Conven- | Compar- | | Compar- | | Compar- | |
|---|---|---|---|---|---|---|---|---|
| | | tional | ative | | ative | | ative | |
| | | Example | Example | Example | Example | | Example | |
| | | 1 | 1 | 1 | 2 | | 3 | |
| Compounded | Part by | 0 | 0.5 | 6.6 | 10 | | 0.1 | |
| amount C | mass | | | | | | | |
| Average | mm | 30 | 50 | 50 | 50 | | 2 | |
| thickness D | | | | | | | | |
| Left side of | | 0.5 | 0.8 | 0.8 | 0.8 | | 0.08 | |
| Expression (2) | | | | | | | | |
| Right side of | | 6.3 | 6.6 | 6.6 | 6.6 | | 5.88 | |
| Expression (2) | | | | | | | | |
| Range of | | Not | Not | Satisfied | Not | | Satisfied | |
| Expression (2) | | satisfied | satisfied | | satisfied | | | |
| Belt width B | mm | 215 | 215 | 215 | 215 | | 215 | |
| Average width W | mm | 150 | 150 | 150 | 150 | | 150 | |
| Ratio W/B | | 0.70 | 0.70 | 0.70 | 0.70 | | 0.70 | |
| Left side of | | 0.52 | 0.52 | 0.52 | 0.52 | | 0.52 | |
| Expression (3) | | | | | | | | |
| Right side of | | 6.42 | 6.42 | 6.42 | 6.42 | | 6.42 | |
| Expression (3) | | | | | | | | |
| Range of | | Not | Not | Not | Not | | Not | |
| Expression (3) | | satisfied | satisfied | satisfied | satisfied | | satisfied | |
| Resistance to loss | | 3 | 3 | 4 | 4 | | 4 | |
| of grip caused | | | | | | | | |
| by heat | | | | | | | | |
| Quietness | | 3 | 3 | 3 | 2 | | 1 | |
| | | | Compar- | | Compar- | Compar- | | |
| | | | ative | | ative | ative | | |
| | | Example | Example | Example | Example | Example | Example | Example |
| | | 2 | 4 | 3 | 5 | 6 | 4 | 5 |
| Compounded | Part by | 0.5 | 0.2 | 0.3 | 10 | 0.2 | 0.3 | 1.5 |
| amount C | mass | | | | | | | |
| Average | mm | 10 | 30 | 30 | 30 | 30 | 30 | 30 |
| thickness D | | | | | | | | |
| Left side of | | 0.2 | 0.5 | 0.5 | 0.5 | 0.5 | 0.5 | 0.5 |
| Expression (2) | | | | | | | | |
| Right side of | | 6 | 6.3 | 6.3 | 6.3 | 6.3 | 6.3 | 6.3 |
| Expression (2) | | | | | | | | |
| Range of | | Satisfied | Not | Not | Not | Not | Not | Satisfied |
| Expression (2) | | | satisfied | satisfied | satisfied | satisfied | satisfied | |
| Belt width B | mm | 215 | 215 | 215 | 215 | 215 | 215 | 215 |
| Average width W | mm | 150 | 50 | 50 | 50 | 10 | 60 | 150 |
| Ratio W/B | | 0.70 | 0.23 | 0.23 | 0.23 | 0.05 | 0.28 | 0.70 |
| Left side of | | 0.52 | 0.24 | 0.24 | 0.24 | 0.13 | 0.27 | 0.52 |
| Expression (3) | | | | | | | | |
| Right side of | | 6.42 | 6.14 | 6.14 | 6.14 | 6.03 | 6.17 | 6.42 |
| Expression (3) | | | | | | | | |
| Range of | | Not | Not | Satisfied | Not | Satisfied | Satisfied | Satisfied |
| Expression (3) | | satisfied | satisfied | | satisfied | | | |
| Resistance to loss | | 4 | 3 | 4 | 4 | 4 | 4 | 4 |
| of grip caused | | | | | | | | |
| by heat | | | | | | | | |
| Quietness | | 3 | 3 | 3 | 2 | 1 | 3 | 3 |

As can be seen from Table 1, each of Examples 1 to 5 had enhanced resistance to loss of grip caused by heat while the quietness was maintained, compared to Conventional Example 1. On the other hand, Comparative Examples 1 and 4 did not achieve the effect of enhancing resistance to loss of grip caused by heat compared to Conventional Example 1 because the compounded amount C of the cyclic polysulfide was less than the range defined by Expression (2) or (3). Comparative Examples 2 and 5 impaired quietness due to increase in hardness of the tread portion because the compounded amount C of the cyclic polysulfide was greater than the range defined by Expression (2) or (3). Comparative Example 3 significantly deteriorated the quietness although the compounded amount C of the cyclic polysulfide satisfied Expression (2) because the average thickness D of the band-like sound absorbing member is too small. Comparative Example 4 significantly deteriorated the quietness although the compounded amount C of the cyclic polysulfide satisfied Expression (3) because the average width W of the band-like sound absorbing member is too small.

1. A pneumatic tire comprising:
a tread portion having an annular shape and extending in a tire circumferential direction;
a pair of sidewall portions disposed on both sides of the tread portion;
a pair of bead portions disposed on an inner side of the sidewall portions in a tire radial direction; and
a band-like sound absorbing member adhered on a tire inner surface of the tread portion in the tire circumferential direction;
a rubber composition constituting the tread portion containing a cyclic polysulfide represented by Formula (1); and
when a compounded amount of the cyclic polysulfide per 100 parts by mass of a sulfur vulcanizable rubber in the rubber composition constituting the tread portion is C and an average thickness of the sound absorbing member in the tire circumferential direction is D, the compounded amount C satisfying Expression (2): 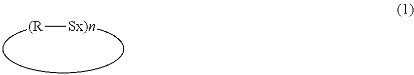
where, R is a substituted or unsubstituted alkylene group having from 2 to 20 carbons, a substituted or unsubstituted oxyalkylene group having from 2 to 20 carbons, or an alkylene group having an aromatic ring; n is an integer of 1 to 20; and x is a number, on average, of 2 to 6;
(D−10)×0.015+0.2<C<(D−10)×0.015+6 (2)
where, D is 10 mm or greater.

2. A pneumatic tire comprising:
a tread portion having an annular shape and extending in a tire circumferential direction;
a pair of sidewall portions disposed on both sides of the tread portion;
a pair of bead portions disposed on an inner side of the sidewall portions in a tire radial direction;
a carcass layer mounted between the pair of bead portions;
a belt layer disposed on an outer circumferential side of the carcass layer in the tread portion; and
a band-like sound absorbing member adhered on a tire inner surface of the tread portion in the tire circumferential direction;
a rubber composition constituting the tread portion containing a cyclic polysulfide represented by Formula (1); and
when a compounded amount of the cyclic polysulfide per 100 parts by mass of a sulfur vulcanizable rubber in the rubber composition constituting the tread portion is C, an average width of the sound absorbing member in the tire circumferential direction is W, and a width of the belt layer is B, the compounded amount C satisfying Expression (3): 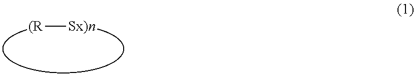
where, R is a substituted or unsubstituted alkylene group having from 2 to 20 carbons, a substituted or unsubstituted oxyalkylene group having from 2 to 20 carbons, or an alkylene group having an aromatic ring; n is an integer of 1 to 20; and x is a number, on average, of 2 to 6;
(W/B)×0.6+0.1<C<(W/B)×0.6+6 (3)
where, W is 50 mm or greater.

3. A pneumatic tire comprising:
a tread portion having an annular shape and extending in a tire circumferential direction;
a pair of sidewall portions disposed on both sides of the tread portion;
a pair of bead portions disposed on an inner side of the sidewall portions in a tire radial direction;
a carcass layer mounted between the pair of bead portions;
a belt layer disposed on an outer circumferential side of the carcass layer in the tread portion; and
a band-like sound absorbing member adhered on a tire inner surface of the tread portion in the tire circumferential direction;
a rubber composition constituting the tread portion containing a cyclic polysulfide represented by Formula (1); and
when a compounded amount of the cyclic polysulfide per 100 parts by mass of a sulfur vulcanizable rubber in the rubber composition constituting the tread portion is C, an average thickness of the sound absorbing member in the tire circumferential direction is D, an average width of the sound absorbing member in the tire circumferential direction is W, and a width of the belt layer is B, in the case where a ratio W/B of the average width W to the width B is less than 0.5, the compounded amount C satisfying Expression (2) and, in the case where the ratio W/B of the average width W to the width B is 0.5 or greater, the compounded amount C satisfying Expression (3): 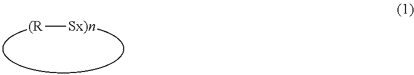
where, R is a substituted or unsubstituted alkylene group having from 2 to 20 carbons, a substituted or unsubstituted oxyalkylene group having from 2 to 20 carbons, or an alkylene group having an aromatic ring; n is an integer of 1 to 20; and x is a number, on average, of 2 to 6;
(D−10)×0.015+0.2<C<(D−10)×0.015+6 (2)
where, D is 10 mm or greater;
(W/B)×0.6+0.1<C<(W/B)×0.6+6 (3)
where, W is 50 mm or greater.

4. The pneumatic tire according to claim 1, wherein a volume of the band-like sound absorbing member is from 10% to 30% relative to a cavity volume of the tire.

5. The pneumatic tire according to claim 1, wherein the band-like sound absorbing member has a missing portion at at least one position in the tire circumferential direction.

6. The pneumatic tire according to claim 1, wherein the R moiety in Formula (1) is —CH₂—CH₂—O—CH₂—O—CH₂—CH₂—.

7. The pneumatic tire according to claim 2, wherein a volume of the band-like sound absorbing member is from 10% to 30% relative to a cavity volume of the tire.

8. The pneumatic tire according to claim 2, wherein the band-like sound absorbing member has a missing portion at at least one position in the tire circumferential direction.

9. The pneumatic tire according to claim 2, wherein the R moiety in Formula (1) is —CH₂—CH₂—O—CH₂—O—CH₂—CH₂—.

10. The pneumatic tire according to claim 3, wherein a volume of the band-like sound absorbing member is from 10% to 30% relative to a cavity volume of the tire.

11. The pneumatic tire according to claim 3, wherein the band-like sound absorbing member has a missing portion at at least one position in the tire circumferential direction.

12. The pneumatic tire according to claim 3, wherein the R moiety in Formula (1) is —CH₂—CH₂—O—CH₂—O—CH₂—CH₂—.
